(19) United States
(12) Patent Application Publication
(10) Pub. No.: US 2026/0032039 A1
(43) Pub. Date: Jan. 29, 2026

(54) NETWORK FAILURE RECOVERY METHOD AND DEVICE FOR LONG TERM EVOLUTION NETWORK

(71) Applicant: Samsung Electronics Co., Ltd., Suwon-si (KR)

(72) Inventor: Lei ZHENG, Suzhou (CN)

(73) Assignee: Samsung Electronics Co., Ltd., Suwon-si (KR)

(21) Appl. No.: 18/818,785

(22) Filed: Aug. 29, 2024

(30) Foreign Application Priority Data
Jul. 29, 2024 (CN) 202411026089.9

(51) Int. Cl. H04L 41/0654; H04W 8/20; H04W 24/04

(52) U.S. Cl. CPC H04L 41/0654; H04W 8/205; H04W 24/04

(57) ABSTRACT

A network failure recovery method for a long term evolution (LTE) network is provided, the network failure recovery method includes downloading an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity, and recovering from the network failure by enabling a second network communication of the second international mobile subscriber identity.

### CROSS-REFERENCE TO RELATED APPLICATION

This application is based on and claims priority under 35 U.S.C. § 119 to Chinese Patent Application No. 202411026089.9 filed on Jul. 29, 2024 in the Chinese Intellectual Property Office, the disclosure of which is incorporated by reference herein in its entirety.

### TECHNICAL FIELD

The present disclosure relates to the field of communication technology. More particularly, the present disclosure relates to a network failure recovery method and device for a long term evolution network.

### BACKGROUND

When a network failure of Evolved Packet System (EPS) Mobility Management (EMM) cause#7 occurs in Long Term Evolution (LTE), according to 3GPP TS 24.301 protocol, a User Equipment (UE) will regard the Packet Switching (PS) service for the first International Mobile Subscriber Identity (IMSI1) as unavailable, and try to access the 2G or 3G network. In this scenario, the UE is not allowed to (or is not configured, according to the 3GPP TS 24.301 protocol, to) re-access to LTE network. All the above restrictions cannot be (or are not) lifted, until the user device is turned off or the card (e.g., a corresponding Subscriber Identity Module (SIM)) is removed. Until these conditions are satisfied, the user's device will stay in (e.g., will remain connected to) the 3G network, and the packet switching service and access to Internet will remain unavailable, which degrades user experience.

It may be seen that, after the user equipment uses an Electrical SIM (eSIM) and receives the Long Term Evolution Network Failure EMM cause#7, the method of recovering packet switching service specified in the 3GPP protocol may only be done (e.g., successfully completed) by manual intervention (e.g., by turning off or removing the card) or the user equipment passively waiting for the 3GPP network (3rd Generation Partnership Project Network, also referred to herein as the 3GPP NW) to recover packet switching service through a Proactive Universal Integrated Circuit Card Command (Proactive UICC Command) triggered by Over-the-Air (OTA) Technology. The user equipment cannot (or is not configured, according to the 3GPP TS 24.301 protocol, to) automatically recover packet switching service, which degrades the user's Internet experience.

An eSIM is a data file that may be downloaded to mobile devices by a corresponding Application Processor (AP) or the network. An electronic subscriber identity module is functionally identical (or similar) to an ordinary physical subscriber identity module (pSIM) card.

### SUMMARY

Embodiments of the present disclosure are to provide a network failure recovery method and device for the long term evolution network, to address the challenge of user devices not being able to access the Internet (applying packet switching service) for a lengthy time period due to the inability of the 3GPP network to trigger an OTA in time (e.g., promptly) after the long term evolution network failure EMM cause#7.

According to embodiments of the present disclosure, there provides a network failure recovery method for a long term evolution network, including downloading an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity, and recovering from the network failure by enabling a second network communication of the second international mobile subscriber identity.

Alternatively or additionally, the recovering from the network may include performing a protocol stack restart of the electronic device based on the downloading of the second international mobile subscriber identity, performing a combined attachment of data domain and international mobile subscriber identity in response to the protocol stack restart, sending the second international mobile subscriber identity to the LTE network, and enabling the second network communication of the second international mobile subscriber identity in response to receiving an indication from the LTE network that the combined attachment was successful.

Alternatively or additionally, the first type of network failure may include a network failure that results in an unavailability of a packet switching service.

Alternatively or additionally, the method may further include downloading the first international mobile subscriber identity to the electronic subscriber identity module of the electronic device before the downloading of the second international mobile subscriber identity, performing the first network communication based on the first international mobile subscriber identity in response to a network communication request, and interrupting a packet switching service in response to the occurrence of the first type of network failure.

Alternatively or additionally, the method may further include performing a Bearer Independent Protocol (BIP) activation corresponding to the first international mobile subscriber identity in response to a network transmission request after the interrupting of the packet switching service, and outputting a notification of failure in opening a channel based on a failure in the BIP activation, the detecting that the first type of network failure has occurred being based on the notification.

According to embodiments of the present disclosure, there provides a network failure recovery device for a long term evolution network, the device including processing circuitry configured to download an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity, and recover from the network failure by enabling a second network communication of the second international mobile subscriber identity.

Alternatively or additionally, the processing circuitry may be configured to perform a protocol stack restart of the electronic device based on the download of the second international mobile subscriber identity, perform a combined attachment of data domain and international mobile subscriber identity in response to the protocol stack restart, send the second international mobile subscriber identity to the LTE network, and enable the second network communication of the second international mobile subscriber identity in response to receiving an indication from the LTE network that the combined attachment was successful.

Alternatively or additionally, the first type of network failure may include a network failure that results in an unavailability of a packet switching service.

Alternatively or additionally, the processing circuitry may be configured to download the first international mobile subscriber identity to the electronic subscriber identity module of the electronic device before downloading the second international mobile subscriber identity, perform the first network communication based on the first international mobile subscriber identity in response to a network communication request, and interrupt a packet switching service in response to the occurrence of the first type of network failure.

Alternatively or additionally, the processing circuitry may be configured to perform a Bearer Independent Protocol (BIP) activation corresponding to the first international mobile subscriber identity in response to a network transmission after the interruption of the packet switching service, and output a notification of failure in opening a channel based on a failure in the BIP activation, the detecting that the first type of network failure has occurred being based on the notification.

According to embodiments of the present disclosure, there provides a non-transitory computer-readable storage medium storing a computer program that, when executed by at least one processor, causes the at least one processor to perform a network failure recovery method for a long term evolution (LTE) network, the network failure recovery method including downloading an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity, and recovering from the network failure by enabling a second network communication of the second international mobile subscriber identity.

According to embodiments of the present disclosure, there provides a computing device, including at least one processor and at least one memory storing a computer program that, when executed by the at least one processor, causes the at least one processor to perform the network failure recovery method for a long term evolution (LTE) network according to embodiments of the present disclosure is implemented.

According to embodiments of the present disclosure, there provides a non-transitory computer program product, wherein computer programs in the computer program product may be executed by a processor of the computer device to complete the network failure recovery method for a long term evolution network according to embodiments of the present disclosure.

The network failure recovery method and device for the long term evolution network according to embodiments of the present disclosure, by downloading a preset (or alternatively, given) second international mobile subscriber identity to an electronic subscriber identity module of an electronic device based on a download request for the preset (or alternatively, given) second international mobile subscriber identity triggered by an application processor on the electronic device, recovering from the network failure by enabling network communication of the preset (or alternatively, given) second international mobile subscriber identity, wherein the download request for the preset (or alternatively, given) second international mobile subscriber identity is triggered by an application processor on the electronic device upon detecting that a predetermined (or alternatively, given) type of network failure has occurred in the electronic device during network communication using the first international mobile subscriber identity of the electronic subscriber identity module, thereby ensuring that the electronic devices using the electronic subscriber identity module may automatically and quickly recover packet switching service after the predefined (or alternatively, given) type of network failure that results in the disabling of packet switching service, thus avoiding (or reducing the duration of) users being unable to access the Internet for a lengthy time period.

Additional aspects and/or advantages of the general concept of the present disclosure will be partially explained in the following description, and still others will be clear from the description, or may be known through the implementation of the general concept of the present disclosure.

### BRIEF DESCRIPTION OF DRAWINGS

The above and other features of embodiments of the present disclosure will become clearer through the following description in conjunction with the drawings that exemplarily illustrate embodiments, wherein:

FIG. 1 illustrates a flowchart of a network failure recovery method for a long term evolution network according to embodiments of the present disclosure;

FIG. 2 illustrates a flowchart of a network failure recovery method for a long term evolution network according to embodiments of the present disclosure;

FIG. 3 illustrates a block diagram of a network failure recovery device for a long term evolution network according to embodiments of the present disclosure; and

FIG. 4 illustrates a schematic diagram of a computing device according to embodiments of the present disclosure.

### DETAILED DESCRIPTION

Reference will now be made in detail to embodiments of the present disclosure, examples of which are illustrated in the drawings, wherein the same reference numerals (or similar numerals) always refer to the same members (or similar members). Embodiments are described below in order to explain the present disclosure by referring to the drawings.

When a user equipment uses the first International Mobile Subscriber Identity (IMSI1) on the electronic subscriber identity module (eSIM), the following four LTE network Non-Access-Stratum (NAS) process failures may be triggered if a Long Term Evolution network failure occurs:
1. the network responds to an attach rejection (ATTACH REJECT) with Evolved Packet System Mobility Management (EMM) cause#7 (packet switching service not allowed);
2. the network triggers a detach request with detach type of “Re-attach not required” & EMM cause#7 (packet switching service not allowed);
3. the network responds to a tracking area update rejection with EMM cause#7 (packet switching service not allowed);
4. the network responds to a service rejection with EMM cause#7 (packet switching service not allowed).

The causes for the above four network failure scenarios are EMM cause#7 (packet switching service not allowed), and when the user equipment receives the EMM cause#7 failure cause, according to 3GPP TS 24.301, the user equipment will regard the packet switching service for that International Mobile Subscriber Identity (e.g., IMSI1) as unavailable, will try to access the 2G and 3G networks, and will not be allowed to (or is not configured, according to the 3GPP TS 24.301 protocol, to) re-access to the Long Term Evolution network. None of the above restrictions will be lifted (according to the 3GPP TS 24.301 protocol) until after the user equipment is turned off or the card is removed.

Thus, the user equipment will fall back to the 3G network according to the protocol, and then only the circuit switching (CS) service may be recovered, while the packet switching (PS) service is no longer available. After the user equipment has fallen back to the 3G network, the network triggers the Bearer Independent Protocol (BIP) and Packet Data Protocol (PDP) activation process for the user equipment to open the channel through Short Message Service (SMS) Point-to-Point (PP) download with Proactive Command, but the user equipment is unable to activate packet data because the packet switching (PS) service is not available, which leads to the failure of the opening of the channel. After that, if the network does not trigger the OTA process, the user equipment will always stay in the 3G network, and the PS service is not available, so the user equipment does not have access to the Internet, which degrades the user experience.

According to embodiments, in order to quickly recover the packet switching service of the user equipment from network failure, when the user equipment uses the first International Mobile Subscriber Identity (IMSI1) on the electronic subscriber identity module, if an application processor on the user equipment detects that the cause for the failure to open a channel is the EMM cause#7, the application processor on the user equipment may automatically trigger the download of a second International Mobile Subscriber Identity (IMSI2) to the electronic subscriber identity module, and the change of International Mobile Subscriber Identity (IMSI) may trigger a protocol stack restart of the user equipment. After the restart of the protocol stack, the user equipment may automatically trigger the Combined type LTE Attach process and carry the second International Mobile Subscriber Identity (IMSI2) to the LTE network, in turn the LTE network will respond with attach success and recover the circuit switching service and packet switching service with the second International Mobile Subscriber Identity (IMSI2), thereby avoiding (or reducing the duration of) the challenge of users being unable to access the Internet (applying packet switching service) for a lengthy time period.

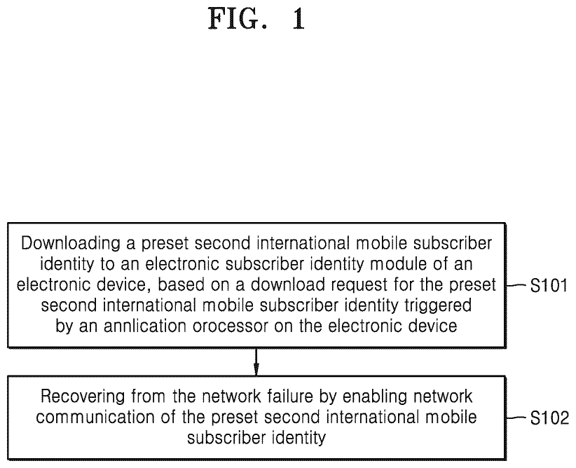

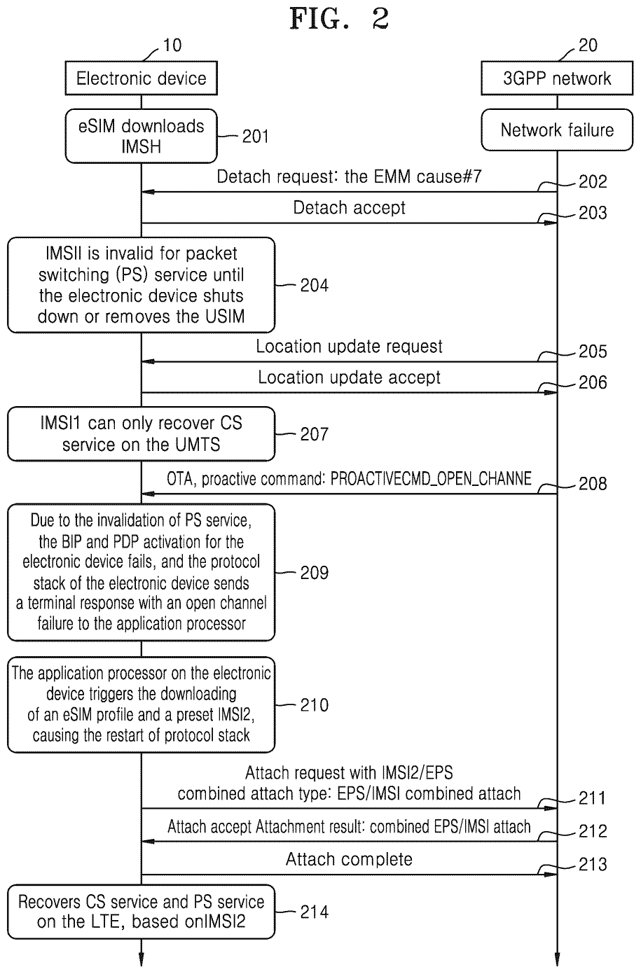

FIG. 1 illustrates a flowchart of a network failure recovery method for a long term evolution network according to embodiments of the present disclosure. The network failure recovery method for the long term evolution network of FIG. 1 may be performed by electronic devices, user equipment, and the like that may be used to perform network communication. According to embodiments, the operations of FIG. 1 may be performed by an electronic device 10 of FIG. 2 (e.g., an application processor of the electronic device 10).

Referring to FIG. 1, in operation S101, based on a download request for a preset (or alternatively, given) second international mobile subscriber identity triggered by an application processor on the electronic device 10, the preset (or alternatively, given) second international mobile subscriber identity may be downloaded to an electronic subscriber identity module of an electronic device 10. Herein, the download request for the preset (or alternatively, given) second international mobile subscriber identity may be triggered by an application processor on the electronic device 10 upon detecting that a predetermined (or alternatively, given) type of network failure has occurred in the electronic device 10 during network communication (e.g., communication with a 3GPP network 20) using a first international mobile subscriber identity of the electronic subscriber identity module. According to embodiments, the second international mobile subscriber identity may be different from the first international mobile subscriber identity. According to embodiments, the 3GPP network 20 may be an LTE network.

In embodiments of the present disclosure, a plurality of international mobile subscriber identities may be preset or given on the electronic device 10, and when it is determined that one of the plurality of international mobile subscriber identities (e.g., the first international mobile subscriber identity or the second international mobile subscriber identity) is to be used, the one international mobile subscriber identity (e.g., the first international mobile subscriber identity or the second international mobile subscriber identity) may be downloaded onto the electronic subscriber identity module of the electronic device 10, so that the electronic device 10 is able to perform network communication based on the one international mobile subscriber identity (e.g., the first international mobile subscriber identity or the second international mobile subscriber identity).

In embodiments of the present disclosure, the predetermined (or alternatively, given) type of network failure includes a network failure that results in unavailability of packet switching service. Herein, the predetermined (or alternatively, given) type of network failure may be, for example, LTE network failure EMM cause#7.

In embodiments of the present disclosure, before the downloading of the preset (or alternatively, given) second international mobile subscriber identity to the electronic subscriber identity module of the electronic device 10, the method may further include: downloading a first international mobile subscriber identity to the electronic subscriber identity module of the electronic device 10; performing network communication based on the first international mobile subscriber identity in response to a network communication request (e.g., a request from the 3GPP network 20); interrupting a packet switching service in response to the occurrence of the predetermined (or alternatively, given) type of network failure, thus making network fault recovery necessary (or prompting network fault recovery, making network fault recovery desirable, etc.). Before the network failure, network communication may be performed (e.g., with the 3GPP network 20) based on the First International Mobile Subscriber Identity. The network failure results in packet switching service not being able to function properly.

In embodiments of the present disclosure, after the interruption of the packet switching service, the method may further include: performing a Bearer Independent Protocol (BIP) activation, in response to a network transmission request from the application processor on the electronic device 10; based on (e.g., in response to) the failure of the BIP activation performed by the first international mobile subscriber identity, outputting a notification of failure in opening a channel, so that the occurrence of the predetermined (or alternatively, given) type of network failure in the electronic device 10 during network communication (e.g., with the 3GPP network 20) using the first international mobile subscriber identity of the electronic subscriber identity module may be detected by an application processor on the electronic device 10 (e.g., the predetermined (or alternatively, given) type of network failure may be detected based on the notification). The BIP protocol is a connection-oriented transport protocol proposed by 3GPP in its specification TS 31.111. The BIP protocol supports mobile networks such as Global System for Mobile Communication (GSM), Code Division Multiple Access (CDMA), Universal Mobile Telecommunications System (UMTS), etc. The BIP protocol contains active commands such as Open Channel, Close Channel, Send Data, Receive Data, Get Channel Status, and events such as Data Available, Channel Status, etc. The BIP protocol allows communication devices and servers to establish connection-oriented data channels. The BIP protocol supports mobile networks such as GSM, CDMA, UMTS, etc. The BIP protocol contains active commands such as Open Channel, Close Channel, Send Data, Receive Data, Get Channel Status, and events such as Data Available, Channel Status, etc., which allow communication devices and servers to establish connection-oriented data channels. The use of BIP protocol avoids the command length limitation of short message (SMS) and improves the speed, which provides a good channel for updating the menu of the dynamic user identification application development tool (SIM Toolkit (STK)) and downloading mobile terminal applications.

As an example, after the network failure, the network communication (e.g., with the 3GPP network 20) of the electronic device 10 is interrupted and the application processor on the electronic device 10 is unable to complete the communication. At this time, the application processor on the electronic device 10 will continue to try to connect to the network (e.g., the 3GPP network 20) in order to complete the communication. The network (e.g., the 3GPP network 20) triggers the Bearer Independent Protocol (BIP) and Packet Data Protocol (PDP) activation process for the electronic device 10 by means of SMS PP download with Proactive Command (OPEN_CHANNEL), while the electronic device 10 is unable to activate packet data because the packet switching (PS) service is not available, which results in the failure to open a channel. When the application processor detects that the cause of the failure to open the channel is the EMM cause#7 failure, it may automatically trigger the download of the preset (or alternatively, given) second international mobile subscriber identify to the electronic subscriber identity module of the electronic device 10, to enable network failure recovery based on the preset (or alternatively, given) second international mobile subscriber identity module.

In operation S102, the network failure is recovered by enabling network communication (e.g., with the 3GPP network 20) of the preset (or alternatively, given) second international mobile subscriber identity. According to embodiments, after recovering from the network failure and reenabling packet switched communication with the 3GPP network 20 (e.g., a 4G network or a 5G network), the electronic device 10 may performed network communication with the 3GPP network 20. For example, the electronic device 10 may generate a first signal (e.g., using the application processor of the electronic device 10), process the first signal to perform one or more among modulating, upconverting, filtering, amplifying and/or encrypting on the first signal, and transmit the processed first signal to the 3GPP network 20 via one or more antennas of the electronic device 10. Additionally or alternatively, the electronic device 10 may receive a second signal from the 3GPP network 20 via the one or more antennas of the electronic device 10, process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application executing on the electronic device 10, storing the processed second signal, sending a response signal to the 3GPP network 20, etc.

In embodiments of the present disclosure, the recovering from the network failure by enabling network communication (e.g., with the 3GPP network 20) of the preset (or alternatively, given) second international mobile subscriber identity may include: performing a protocol stack restart of the electronic device 10, based on the download of the preset (or alternatively, given) second international mobile subscriber identity; performing a combined attachment of data domain and international mobile subscriber identity in response to the restart of the protocol stack; sending the preset (or alternatively, given) second international mobile subscriber identity to the network (e.g., the 3GPP network 20); in response to receiving feedback of a success of the combined attachment from the network (e.g., the 3GPP network 20), enabling the network communication (e.g., in response to receiving an indication from the 3GPP network 20 that the combined attachment was successful) of the preset (or alternatively, given) second international mobile subscriber identity, thereby recovering the packet switching service and avoiding (or reducing the duration of) the user being unable to access the Internet for a lengthy time. In addition, the network communication function may include packet switching service, circuit switching service, and other services, to which the present disclosure is not limited.

FIG. 2 illustrates a flowchart of a network failure recovery method for a long term evolution network according to embodiments of the present disclosure. According to embodiments, the operations discussed in connection with FIG. 2 may be performed by the electronic device 10 and the 3GPP network 20. For example, operations 201, 203, 204, 205, 207, 209, 210, 211, 213 and 214 may be performed by the electronic device 10 (e.g., the application processor of the electronic device 10), operations 202, 206, 208 and 212 may be performed by the 3GPP network 20,.

According to embodiments, a wireless communication network between electronic device 10 and the 3GPP network 20 may support communication between multiple users by sharing available network resources. For example, in the wireless communication network, information may be transmitted in various multiple access schemes, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, and OFDM-CDMA. The electronic device 10 may communicate with the 3GPP network 20 through an uplink UL and a downlink DL.

According to embodiments, the 3GPP network 20 may refer to a fixed station that communicates with electronic devices and/or base stations, and may exchange data and control information by communicating with electronic devices and/or base stations. For example, the 3GPP network 20 may also be referred to as a base station, a Node B, an evolved-Node B (eNB), a next generation Node B (gNB), a sector, a site, a base transceiver system (BTS), an access point (AP), a relay node, a remote radio head (RRH), a radio unit (RU), a small cell, or the like. In the present specification, a base station or a cell may be interpreted in a comprehensive sense to indicate some area or function covered by a base station controller (BSC) in CDMA, a Node-B in WCDMA, an eNB in LTE, a gNB or sector (site) in 5G, and the like, and may cover all the various coverage areas such as megacell, macrocell, microcell, picocell, femtocell and relay node, RRH, RU, and small cell communication range.

As shown in FIG. 2, at operation 201, the eSIM downloads a first International Mobile Subscriber Identity (IMSI1) for network communication based on the first International Mobile Subscriber Identity. Subsequently, a network failure occurs in the long term evolution network (e.g., the 3GPP network 20), and at operation 202, the long term evolution network (e.g., the 3GPP network 20) sends a detach request (the EMM cause#7) to the electronic device 10. At operation 203, the electronic device 10 sends a detach acceptance to the long term evolution network (e.g., the 3GPP network 20). At operation 204, the first international mobile subscriber identity is invalid (e.g., is identified by the electronic device 10 as being invalid according to 3GPP protocol) for packet switching (PS) service until the electronic device 10 shuts down or removes the USIM. At operation 205, the electronic device 10 sends a location update request to the 3GPP network 20. At operation 206, the 3GPP network 20 sends a location update acceptance to the electronic device 10. At operation 207, the first International Mobile Subscriber Identity may only recover circuit switching (CS) service on the Universal Mobile Telecommunications System (UMTS, e.g., the 3GPP network 20). At operation 208, the 3GPP network 20 sends an OTA to the electronic device 10 carrying a proactive command (PROACTIVE_CMD_OPEN_CHANNEL). At operation 209, due to the invalidation of the packet switching (PS) service, the bearer independent protocol (BIP) and packet data protocol (PDP) activation for the electronic device 10 fails, and the protocol stack of the electronic device 10 sends a terminal response with an open channel failure to the application processor.

At operation 210, the application processor on the electronic device 10 triggers the downloading of an eSIM profile and a preset (or alternatively, given) second International Mobile Subscriber Identity (IMSI2), causing the restart of protocol stack. At operation 211, the electronic device 10 sends an attach request with the second International Mobile Subscriber Identity (IMSI2) and the EPS combined attach type (combined EPS/IMSI type attach) to the long term evolution network (e.g., the 3GPP network 20). At operation 212, the long term evolution network (e.g., the 3GPP network 20) sends to the electronic device 10 an attach acceptance having an attachment result (combined EPS/IMSI attach). At operation 213, the electronic device 10 sends an attach completion to the long term evolution network (e.g., the 3GPP network 20). At operation 214, the electronic device 10 recovers circuit-switching (CS) service and packet-switching (PS) service on the long term evolution network (e.g., the 3GPP network 20) based on the second International Mobile Subscriber Identity (IMSI2).

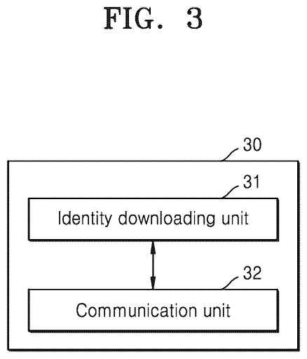

The network failure recovery method for the long term evolution network according to embodiments of the present disclosure has been described above in conjunction with FIG. 1 and FIG. 2. Hereinafter, the network failure recovery device for the long term evolution network according to embodiments of the present disclosure will be described with reference to FIG. 3.

FIG. 3 illustrates a block diagram of a network failure recovery device for the long term evolution network according to embodiments of the present disclosure.

Referring to FIG. 3, network failure recovery device 30 for the long term evolution network includes an identity downloading unit 31 and/or a communication unit 32. According to embodiments, the network failure recovery device 30 may be the same as, or similar to, the electronic device 10 of FIG. 2, however embodiments are not limited thereto. According to embodiments, the network failure recovery device 30 may be included in the electronic device 10 of FIG. 2.

The identity downloading unit 31 is configured to download a preset (or alternatively, given) second international mobile subscriber identity to an electronic subscriber identity module of an electronic device (e.g., the electronic device 10), based on a download request for the preset (or alternatively, given) second international mobile subscriber identity triggered by an application processor on the electronic device.

In embodiments of the present disclosure, the identity downloading unit 31 may be further configured to download a first international mobile subscriber identity to the electronic subscriber identity module of the electronic device.

The communication unit 32 is configured to recover from the network failure by enabling network communication of the preset (or alternatively, given) second international mobile subscriber identity. Herein, the download request for the preset (or alternatively, given) second international mobile subscriber identity is triggered by an application processor on the electronic device upon detecting that a predetermined (or alternatively, given) type of network failure has occurred in the electronic device during network communication using the first international mobile subscriber identity of the electronic subscriber identity module.

In embodiments of the present disclosure, the predetermined (or alternatively, given) type of network failure may include a network failure that results in unavailability of packet switching service.

In embodiments of the present disclosure, the communication unit 32 may be configured to: perform a protocol stack restart of the electronic device, based on the download of the preset (or alternatively, given) second international mobile subscriber identity; perform a combined attachment of data domain and international mobile subscriber identity in response to the restart of the protocol stack; send the preset (or alternatively, given) second international mobile subscriber identity to the network; in response to receiving feedback of a success of the combined attachment from the network, enable the network communication of the preset (or alternatively, given) second international mobile subscriber identity.

In embodiments of the present disclosure, the communication unit 32 may be further configured to perform network communication based on the first international mobile subscriber identity in response to a network communication request.

In embodiments of the present disclosure, the network failure recovery device 30 may further include a service interruption unit (not shown) configured to interrupt a packet switching service in response to the occurrence of the predetermined (or alternatively, given) type of network failure.

In embodiments of the present disclosure, the service interruption unit is further configured to: perform a Bearer Independent Protocol (BIP) activation, in response to a network transmission request from the application processor on the electronic device; based on the failure of the BIP activation performed by the first international mobile subscriber identity, output a notification of failure in opening a channel, so that the occurrence of the predetermined (or alternatively, given) type of network failure in the electronic device during network communication using the first international mobile subscriber identity of the electronic subscriber identity module is detected by an application processor on the electronic device.

In addition, according to embodiments of the present disclosure, there also provides a non-transitory computer-readable storage medium having a computer program stored thereon, and when the computer program is executed, the network failure recovery method for the long term evolution network according to embodiments of the present disclosure is implemented.

In embodiments of the present disclosure, the non-transitory computer-readable storage medium may carry one or more programs that, when executed, may implement the following operations: downloading a preset (or alternatively, given) second international mobile subscriber identity to an electronic subscriber identity module of an electronic device, based on a download request for the preset (or alternatively, given) second international mobile subscriber identity triggered by an application processor on the electronic device; recovering from the network failure by enabling network communication of the preset (or alternatively, given) second international mobile subscriber identity, wherein the download request for the preset (or alternatively, given) second international mobile subscriber identity is triggered by an application processor on the electronic device upon detecting that a predetermined (or alternatively, given) type of network failure has occurred in the electronic device during network communication using the first international mobile subscriber identity of the electronic subscriber identity module, thereby ensuring that the electronic devices using the electronic subscriber identity module may automatically and quickly recover packet switching service after the predefined (or alternatively, given) type of network failure that results in the disabling of packet switching service, thus avoiding (or reducing the duration of) users being unable to access the Internet for a lengthy time period.

The non-transitory computer-readable storage medium may be, for example, but not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In embodiments of the present disclosure, a computer-readable storage medium may be any tangible medium that contains or stores a computer program that may be used by or in conjunction with an instruction execution system, apparatus, or device. The computer program contained on the computer-readable storage medium may be transmitted using any appropriate medium, including but not limited to wire, fiber optic cable, RF (radio frequency), etc., or any suitable combination of the above. The computer-readable storage medium may be included in any device, and it may also exist alone without being incorporated into the device.

In addition, according to embodiments of the present disclosure, there also provides a non-transitory computer program product, wherein instructions in the computer program product may be executed by a processor of the computer device to complete the network failure recovery method for the long term evolution network according to embodiments of the present disclosure.

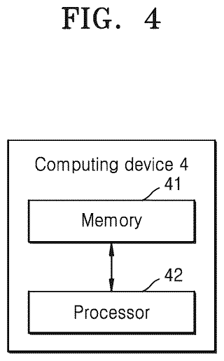

The network failure recovery device 30 for the long term evolution network according to embodiments of the present disclosure has been described above in conjunction with FIG. 3. Next, a computing device according to embodiments of the present disclosure will be described in conjunction with to FIG. 4.

FIG. 4 illustrates a schematic diagram of a computing device according to embodiments of the present disclosure.

Referring to FIG. 4, a computing device 4 according to embodiments of the present disclosure may include a memory 41 and a processor 42, and the memory 41 stores a computer program. When the computer program is executed by the processor 42, the network failure recovery method for the long term evolution network according to embodiments of the present disclosure is implemented. According to embodiments, the computing device 4 may be the same as (or similar to) the electronic device 10 of FIG. 2, and/or the processor 42 may be the application processor of the electronic device 10 of FIG. 2, but embodiments are not limited thereto. According to embodiments, the computing device 4 may be the same as (or similar to) the network failure recovery device 30 of FIG. 3, and/or the identity downloading unit 31, the communication unit 32 of FIG. 3 and/or the service interruption unit may be implemented using the processor 42.

In embodiments of the present disclosure, when the computer program is executed by the processor 42, the following operations may be implemented: downloading a preset (or alternatively, given) second international mobile subscriber identity to an electronic subscriber identity module of an electronic device, based on a download request for the preset (or alternatively, given) second international mobile subscriber identity triggered by an application processor on the electronic device; recovering from the network failure by enabling network communication of the preset (or alternatively, given) second international mobile subscriber identity, wherein the download request for the preset (or alternatively, given) second international mobile subscriber identity is triggered by an application processor on the electronic device upon detecting that a predetermined (or alternatively, given) type of network failure has occurred in the electronic device during network communication using the first international mobile subscriber identity of the electronic subscriber identity module, thereby ensuring that the electronic devices using the electronic subscriber identity module may automatically and quickly recover packet switching service after the predefined (or alternatively, given) type of network failure that results in the disabling of packet switching service, thus avoiding (or reducing a duration of) users being unable to access the Internet for a lengthy time period.

The computing device in embodiments of the present disclosure may include, but are not limited to, devices such as a mobile telephone, a laptop, a PDA (personal digital assistant), a PAD (tablet computer), a desktop computer, etc. The computing device shown in FIG. 4 is only an example, and should not impose any limitation on the function and scope of use of embodiments of the present disclosure.

The network failure recovery method and device for the long term evolution network according to embodiments of the present disclosure have been described above with reference to FIGS. 1-4. However, it should be understood: the network failure recovery device for the long term evolution network shown in FIG. 3 may be respectively configured as software, hardware, firmware or any combination of the above to perform specific functions, and the computing device shown in FIG. 4 is not limited to including the above shown components, but some components may be added or deleted according to needs (or varying implementations), and the above components may also be combined.

The network failure recovery method and device for the long term evolution network according to embodiments of the present disclosure, by downloading a preset (or alternatively, given) second international mobile subscriber identity to an electronic subscriber identity module of an electronic device based on a download request for the preset (or alternatively, given) second international mobile subscriber identity triggered by an application processor on the electronic device, recovering from the network failure by enabling network communication of the preset (or alternatively, given) second international mobile subscriber identity, wherein the download request for the preset (or alternatively, given) second international mobile subscriber identity is triggered by an application processor on the electronic device upon detecting that a predetermined (or alternatively, given) type of network failure has occurred in the electronic device during network communication using the first international mobile subscriber identity of the electronic subscriber identity module, thereby ensuring that the electronic devices using the electronic subscriber identity module may automatically and quickly recover packet switching service after the predefined (or alternatively, given) type of network failure that results in the disabling of packet switching service, thus avoiding (or reducing the duration of) users being unable to access the Internet for a lengthy time period.

Conventional devices and methods for performing network communication respond to a packet switching service failure as specified in 3GPP protocols. For example, in response to receiving an indication that packet switching service is not allowed in connection with a failure in network communication (e.g., with a network that facilitates communication using packet switching, such as a 4G or 5G LTE network) using a first International Mobile Subscriber Identity (IMSI) on a Subscriber Identity Module (SIM), the conventional devices and methods follow specific restrictions. These restrictions include limiting network connections to those of a 2G or 3G network (e.g., a network that facilitates communication using circuit switching), without attempting to re-access a packet switching network (e.g., the 4G or 5G LTE network), until one of a first condition or a second condition is met. The first condition includes either turning the conventional device off or physically removing (and reinserting) the SIM of the conventional device. The second condition includes recovery of the packet switching service performed by the packet switching network using a Proactive Universal Integrated Circuit Card Command (Proactive UICC Command) triggered by Over-the-Air (OTA) Technology. Recovery of the packet switching service through satisfaction of the first condition places an excessive burden on users of the conventional devices, and thus, degrades the users' experience. Also, recovery through satisfaction of the second condition involves excessive delay in accessing the packet switching service during which the users of the conventional devices are unable to access the Internet.

However, according to embodiments, improved devices and methods are provided for performing network communication. For example, the improved devices and methods may download a second IMSI to a SIM in response to detecting that a network communication failure has occurred, while using a first IMSI on the SIM, that renders packet switching service unavailable. The improved devices and methods may then promptly recover the packet switching service using the second IMSI. Accordingly, the improved devices and methods may recover the packet switching service without either turning the conventional device off or physically removing (and reinserting) the SIM of the improved device. Also, the improved devices and methods may recover the packet switching service without waiting for the packet switching network to send a Proactive UICC Command triggered by OTA Technology. Therefore, the improved devices and methods override the conventional process for recovering from a packet switching service failure specified in the 3GPP protocols, and thereby, overcome the deficiencies of the conventional devices and methods to at least improve user experience and/or reduce recovery delay.

According to embodiments, operations described herein as being performed by the electronic device 10, the application processor of the electronic device 10, the 3GPP network 20, the 3G network 25, the network failure recovery device 30, the identity downloading unit 31, the communication unit 32, the service interruption unit of the network failure recovery device 30, the computing device 4 and/or the processor 42 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 41). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although the present disclosure has been specifically shown and described with reference to embodiments thereof, those skilled in the art should understand that various changes of the forms and details may be made without departing from the spirit and scope of the present disclosure as defined by the claims.

1. A network failure recovery method for a long term evolution (LTE) network, the network failure recovery method comprising:
downloading an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity; and
recovering from the network failure by enabling a second network communication of the second international mobile subscriber identity.

2. The network failure recovery method according to claim 1, wherein the recovering from the network failure comprises:
performing a protocol restart of the electronic device based on the downloading of the second international mobile subscriber identity;
performing a combined attachment of data domain and international mobile subscriber identity in response to the protocol stack restart;
sending the second international mobile subscriber identity to the LTE network; and
enabling the second network communication of the second international mobile subscriber identity in response to receiving an indication from the LTE network that the combined attachment was successful.

3. The network failure recovery method according to claim 1, wherein the first type of network failure comprises a network failure that results in an unavailability of a packet switching service.

4. The network failure recovery method according to claim 1, further comprising:
downloading the first international mobile subscriber identity to the electronic subscriber identity module of the electronic device before the downloading of the second international mobile subscriber identity;
performing the first network communication based on the first international mobile subscriber identity in response to a network communication request; and
interrupting a packet switching service in response to the occurrence of the first type of network failure.

5. The network failure recovery method according to claim 4, further comprising:
performing a Bearer Independent Protocol (BIP) activation corresponding to the first international mobile subscriber identity in response to a network transmission request cuitry
outputting a notification of failure in opening a channel based on a failure in the BIP activation, the detecting that the first type of network failure has occurred being based on the notification.

6. A network failure recovery device for a long term evolution LTE network, comprising:
processing circuitry configured to
download an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity, and
recover from the network failure by enabling a second network communication of the second international mobile subscriber identity.

7. The network failure recovery device according to claim 6, wherein the processing circuitry is configured to:
perform a protocol stack restart of the electronic device based on the download of the second international mobile subscriber identity;
perform a combined attachment of data domain and international mobile subscriber identity in response to the protocol stack restart;
send the second international mobile subscriber identity to the LTE network; and
enable the second network communication of the second international mobile subscriber identity in response to receiving an indication from the LTE network that the combined attachment was successful.

8. A network failure recovery device according to claim 6, wherein the first type of network failure comprises a network failure that results in an unavailability of a packet switching service.

9. The network failure recovery device according to claim 6, wherein the processing circuitry is configured to:
download the first international mobile subscriber identity to the electronic subscriber identity module of the electronic device before downloading the second international mobile subscriber identity;
perform the first network communication based on the first international mobile subscriber identity in response to a network communication request; and
interrupt a packet switching service in response to the occurrence of the first type of network failure.

10. The network failure recovery device according to claim 9, wherein the processing circuitry is configured to:
perform a Bearer Independent Protocol (BIP) activation corresponding to the first international mobile subscriber identity in response to a network transmission after the interruption of the packet switching service; and
output a notification of failure in opening a channel based on a failure in the BIP activation, the detecting that the first type of network failure has occurred being based on the notification.

11. A non-transitory computer-readable storage medium storing a computer program that, when executed by at least one processor, causes the at least one processor to perform a network failure recovery method for a long term evolution (LTE) network, the network failure recovery method comprising:
downloading an international mobile subscriber identity to an electronic subscriber identity module of an electronic device based on a download request for the international mobile subscriber identity, the download request being triggered in response to detecting that a first type of network failure has occurred during a first network communication, the first network communication being performed using a first international mobile subscriber identity of the electronic subscriber identity module, and the downloaded international mobile subscriber identity being a second international mobile subscriber identity; and
recovering from the network failure by enabling a second network communication of the second international mobile subscriber identity.

12. (canceled)

13. The non-transitory computer-readable storage medium according to claim 11, wherein the recovering from the network failure comprises:
performing a protocol stack restart of the electronic device based on the downloading of the second international mobile subscriber identity;
performing a combined attachment of data domain and international mobile subscriber identity in response to the protocol stack restart;
sending the second international mobile subscriber identity to the LTE network; and
enabling the second network communication of the second international mobile subscriber identity in response to receiving an indication from the LTE network that the combined attachment was successful.

14. The non-transitory computer-readable storage medium according to claim 11, wherein the first type of network failure comprises a network failure that results in an unavailability of a packet switching service.

15. The non-transitory computer-readable storage medium according to claim 11, wherein the network failure recovery method further comprises:
downloading the first international mobile subscriber identity to the electronic subscriber identity module of the electronic device before the downloading of the second international mobile subscriber identity;
performing the first network communication based on the first international mobile subscriber identity in response to a network communication request; and
interrupting a packet switching service in response to the occurrence of the first type of network failure.

16. The non-transitory computer-readable storage medium according to claim 15, wherein the network failure recovery method further comprises:
performing a Bearer Independent Protocol (BIP) activation corresponding to the first international mobile subscriber identity in response to a network transmission request after the interrupting of the packet switching service; and
outputting a notification of failure in opening a channel based on a failure in the BIP activation, the detecting that the first type of network failure has occurred being based on the notification.

17. The network failure recovery method according to claim 1, further comprising:
performing the second network communication with the LTE network, the second network communication including
transmitting a first communication signal to the LTE network, or
receiving a second communications signal from the LTE network.

18. The network failure recovery device according to claim 6, wherein the processing circuitry is configured to perform the second network communication with the LTE network, the second network communication including:
transmitting a first communication signal to the LTE network; or
receiving a second communications signal from the LTE network.

19. The non-transitory computer-readable storage medium according to claim 11, wherein the network failure recovery method further comprises:
performing the second network communication with the LTE network, the second network communication including
transmitting a first communication signal to the LTE network, or
receiving a second communications signal from the LTE network.

20. (canceled)
